(19) United States
(12) Patent Application Publication
(10) Pub. No.: US 2016/0282786 A1
(43) Pub. Date: Sep. 29, 2016

(54) PAPER FEEDING APPARATUS AND IMAGE FORMING APPARATUS

(71) Applicant: CASIO COMPUTER CO., LTD., Tokyo (JP)

(72) Inventor: Hirokazu TOSHIYUKI, Iruma-shi (JP)

(73) Assignee: CASIO COMPUTER CO., LTD., Tokyo (JP)

(21) Appl. No.: 15/014,341

(22) Filed: Feb. 3, 2016

(30) Foreign Application Priority Data
Mar. 27, 2015 (JP) 2015-066167

(51) Int. Cl. G03G 15/00; B65H 1/04

(52) U.S. Cl. CPC G03G 15/6529; B65H 1/04; B65H 2301/51256; B65H 2801/06; B65H 2301/4234

(57) ABSTRACT

A sheet cassette includes a housing, a cassette bottom plate, a side regulation plate, and a DF prevention plate. Spacers are respectively arranged at three portions, that is, the center and both sides of the cassette bottom plate on the sheet feeding side. When a curled release sheet is placed on the sheet cassette, the spacers partially support the front end of the release sheet in the sheet feeding direction from below. Therefore, force acts on the release sheet to suppress the height of the curl by the own weight of the release sheet. When the curl of the release sheet is suppressed, the curled release sheet is stably fed.

### CROSS-REFERENCE TO RELATED APPLICATION

This application is based upon and claims the benefit of priority from the prior Japanese Patent Application No. 2015-066167, filed Mar. 27, 2015, the entire contents of which are incorporated herein by reference.

### BACKGROUND OF THE INVENTION

1. Field of the Invention

The present invention relates to a paper feeding apparatus and an image forming apparatus.

2. Description of the Related Art

Conventionally, as a method for printing a desired image or a design such as a logo on a transfer target medium such as a fabric product including a T-shirt, a sweat shirt, or work clothes, wood, or a metal plate, a method and an apparatus have been known by which a thermal transfer print sheet is created in which an image (toner image) to be thermally transferred to a transfer target medium and a transfer base material (thermoplastic resin) serving to adhere to the transfer target medium have been fixed on a release sheet (refer to Japanese Patent Application Laid-Open (Kokai) Publication No. 2013-068862).

When an image is to be transferred to a transfer target medium such as a T-shirt, a thermal transfer print sheet is overlaid on the transfer target medium with its surface (hereinafter referred to as a front surface) where a transfer object has been fixed opposing the transfer target medium, and heat and pressure are applied from the rear surface of the thermal transfer print sheet by using an iron or the like, whereby the image is fixed on the transfer target medium.

### SUMMARY OF THE INVENTION

In accordance with one aspect of the present invention, there is provided a paper feeding apparatus comprising: a bottom plate section where a printing target medium is placed; and a plurality of supporting sections which are arranged at predetermined intervals in a direction perpendicular to a conveyance direction of the printing target medium, and support the printing target medium from below.

In accordance with another aspect of the present invention, there is provided an image forming apparatus comprising: a transfer section which transfers a toner image to a printing target medium; and a sheet feeding section which feeds the printing target medium to the transfer section, wherein the sheet feeding section comprises a bottom plate section where the printing target medium is placed, and a plurality of supporting sections having a predetermined height arranged at predetermined intervals in a direction perpendicular to a conveyance direction of the printing target medium.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a cross-sectional view showing the internal structure of an image forming apparatus 1 according to an embodiment of the present invention;

FIG. 2 is a perspective view showing the structure of a sheet cassette 21 according to the present embodiment;

FIG. 3A is a cross-sectional view showing the cross-sectional structure of the sheet cassette 21 including no spacers 44a, 44b, and 44c when viewed from the arrow A direction in FIG. 2;

FIG. 3B is a cross-sectional view showing the cross-sectional structure of the sheet cassette 21 including spacers 44a, 44b, and 44c when viewed from the arrow A direction in FIG. 2;

FIG. 4A is a cross-sectional view showing the cross-sectional structure of the sheet cassette 21 including no spaces 44a, 44b, and 44c when viewed from the arrow B direction in FIG. 2;

FIG. 4B is a cross-sectional view showing the cross-sectional structure of the sheet cassette 21 including the spaces 44a, 44b, and 44c when viewed from the arrow B direction in FIG. 2;

FIG. 5A is a cross-sectional view showing the structure of a sheet cassette 100 in a general image forming apparatus having plain paper 101 placed thereon; and

FIG. 5B is a cross-sectional view showing the structure of a sheet cassette 100 in a general image forming apparatus having a release sheet 19 (transfer target medium) placed thereon.

### DETAILED DESCRIPTION OF THE PREFERRED EMBODIMENT

An embodiment of the present invention will hereinafter be described with reference to the drawings.

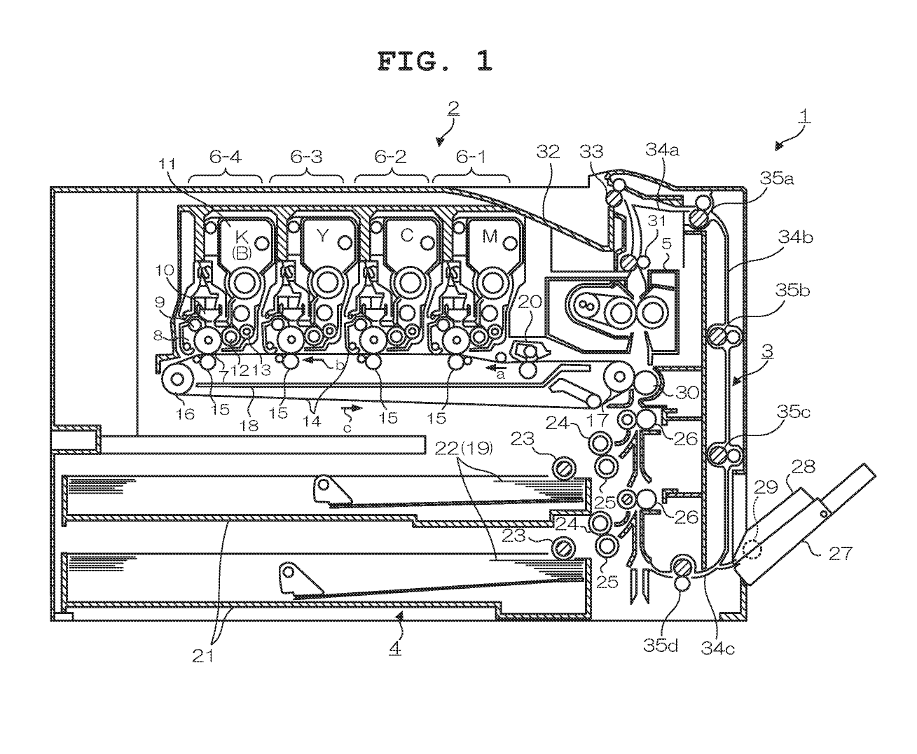

FIG. 1 is a cross-sectional view showing the internal structure of an image forming apparatus 1 according to an embodiment of the present invention. The image forming apparatus 1 of the present embodiment In FIG. 1 adopts an intermediate transfer system where a toner image is transferred to an intermediate transfer belt and then secondarily transferred to paper vertically conveyed to a secondary transfer section via the intermediate transfer belt. However, the present invention can be applied not only to this intermediate transfer system but also to other transfer systems such as a direct transfer system for directly transferring a toner image to paper.

This image forming apparatus 1 includes an image forming section 2, a two-sided printing conveyance unit 3, a sheet feeding section 4, and a fixing section 5. The image forming section 2 has a structure where four image forming units (development devices) 6 (6-1, 6-2, 6-3, and 6-4) have been provided side-by-side in multiple stages. The three image forming units 6-1, 6-2, and 6-3 respectively form color images with toners in magenta (M), cyan (C), and yellow (Y) serving as subtractive primary colors. The fourth image forming unit 6-4 subsequent to the three image forming units 6-1, 6-2, and 6-3 forms a monochrome image in black (K). The toner images in the four colors are overlaid on paper to form a full-color image.

Note that, in the manufacture of a thermal transfer sheet, a toner cartridge (black (K)) in the image forming unit 6-4 is replaced with a toner cartridge (binder (B)) containing a binder toner.

The image forming units 6-1 to 6-4 respectively have the same structures except for the color and the type of a developer contained in a developing unit. Therefore, their structures will be described using the structure of the image forming unit 6-4 as an example.

The image forming unit 6 has a photosensitive drum 7 in its lowermost portion. The peripheral surface of the photosensitive drum 7, for example, is formed of an organic photoconductive material, and a cleaner 8, a charging roller 9, an optical writing head 10, and a developing roller 12 in a developing device 11 are arranged to come in contact with the peripheral surface of the photosensitive drum 7 or surround the vicinity thereof.

The developing device 11 has in its upper portion a toner container containing the toner of one of magenta (M), cyan (C), yellow (Y), and black (K) indicated by M, C, Y, and K in the drawing, and has in its intermediate portion a toner replenishing mechanism oriented downward.

The developing device 11 has in its lower portion the above-described developing roller 12 in a lateral opening, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged in proximity to the upper surface of the photosensitive drum 7 between the charging roller 9 and the developing device 11.

Also, in an area near the lower surface of the photosensitive drum 7, an intermediate transfer belt 14 is arranged, and a primary transfer roller 15 is pressed toward the lower surface of the photosensitive drum 7 with the intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end at a substantially central portion of the apparatus body in the drawing. This intermediate transfer belt 14 is stretched between a driving roller 16 and a driven roller 17, and is cyclically driven in the counterclockwise direction in the drawing by the driving roller 16 so as to cyclically move in the counterclockwise direction indicated by arrows a, b, and c in the drawing. On the surface of the intermediate transfer belt 14, a belt cleaner 20 is arranged to come in contact therewith. This belt cleaner 20 removes a waste toner from the top of the intermediate transfer belt 14.

The photosensitive drum 7 rotates in the clockwise direction in the drawing. First, this photosensitive drum 7 is initialized when the peripheral surface of the photosensitive drum 7 is uniformly charged by electric charge from the charging roller 9. Subsequently, an electrostatic latent image is formed on the peripheral surface of the photosensitive drum 7 by optical writing from the optical writing head 10 based on printing information.

Then, the electrostatic latent image is changed to a toner image (developed) using toner contained in the developing device 11 by development processing by the developing roller 12. Subsequently, the toner image acquired by the development onto the peripheral surface of the photosensitive drum 7 is primarily transferred to the belt surface of the intermediate transfer belt 14 by the primary transfer roller 15 along with the rotation of the photosensitive drum 7. Then, the intermediate transfer belt 14 conveys a sheet 22 to a transfer position where transfer to the sheet 22 is performed so as to further transfer (secondarily transfer) the toner image primarily transferred to the belt surface.

A belt position control mechanism 18 in FIG. 1 includes a primary transfer roller 15 constituted by a conductive foamed sponge that is pressed against the lower peripheral surface of the photosensitive drum 7 via the intermediate transfer belt 14. This belt position control mechanism 18 vertically moves the three primary transfer rollers 15 respectively corresponding to the three image forming units 6-1, 6-2, and 6-3 in magenta (M), cyan (C), and yellow (Y) simultaneously in synchronization using a clunk and a slider and cam mechanism by the rotation of a driving shaft (not shown). Then, the belt position control mechanism 18 vertically moves one primary transfer roller 15 corresponding to the image forming unit 6-4 in black (K) in the same period as that of the three primary transfer rollers 15 at timing different from that of the three primary transfer rollers 15 so that the intermediate transfer belt 14 comes in contact with or separates from the photosensitive drum 7.

More specifically, the belt position control mechanism. 18 switches the position of the intermediate transfer belt 14 to a position for a full-color mode (the primary transfer rollers 15 corresponding to all of the four image forming units 6-1 to 6-4 come in contact with the photosensitive drum 7 via the intermediate transfer belt 14), a position for a monochrome mode (only the primary transfer roller 15 corresponding to the image forming unit 6-4 comes in contact with the photosensitive drum 7), and a position for a non-transfer mode (the primary transfer rollers 15 corresponding to all of the four image forming units 6-1 to 6-4 separate from the photosensitive drum 7).

The sheet feeding section 4 (sheet feeder) includes two sheet cassettes 21 arranged in two upper and lower stages, and a large number of cut paper-like sheets 22 are stored in one or both of the sheet cassettes 21 in the sheet feeding section 4. Note that, in the manufacture of a thermal transfer print sheet, release sheets 19 (transfer target media) are set on the sheet cassette 21 instead of the sheets 22. A paper extraction roller 23, a feed roller 24, a separating roller 25, and a standby conveyance roller pair 26 are arranged in the vicinity of (at the right in the drawing) of each of sheet feed ports of the two sheet cassettes 21.

The sheets 22 are conveyed from the sheet cassette 21 one by one by the rotation of the paper extraction roller 23, and are fed to the standby conveyance roller pair 26 via the feed roller 24 and the separating roller 25. Alternatively, when the thickness and the size of the sheet 22 are peculiar, the sheet 22 is fed to the standby conveyance roller pair 26 via a sheet feeding roller 29 from above a Multi Paper Feeder (MPF) tray 28 mounted on an opened mounting section 27.

A secondary transfer roller 30 in FIG. 1, which comes in pressure contact with the driven roller 17 via the intermediate transfer belt 14, is arranged in the paper conveyance direction (in the vertically upward direction in the drawing) of the standby conveyance roller pair 26. The intermediate transfer belt 14, the driven roller 17, and the secondary transfer roller 30 form a secondary transfer section where secondary transfer to the sheet 22 is performed.

The fixing section 5 including a belt-type thermal fixing unit is arranged on the lower flow side (on the upper side in the drawing) of the secondary transfer section. A conveyance roller pair 31 which conveys the sheet 22 after fixing from the fixing section 5, and a paper ejection roller pair 33 which ejects the conveyed sheet 22 to a paper ejection tray 32 formed on the upper surface of the apparatus are arranged on the further lower flow side of the fixing section 5.

The two-sided printing conveyance unit 3 includes a return path branched in the right lateral direction in the drawing from a conveyance path in an intermediate portion between the conveyance roller pair 31 and the paper ejection roller pair 33. This return path includes a start return path 34a, an intermediate return path 34b bent downward, an end return path 34c bent in the left lateral direction for conclusively reversing the returned sheet 22, and four return roller pairs 35a, 35b, 35c, and 35d arranged halfway in the return paths. An outlet of the end return path 34c connects to a conveyance path directed toward the standby conveyance roller pair 26 corresponding to the sheet cassette 21 in a lower area in the sheet feeding section 4.

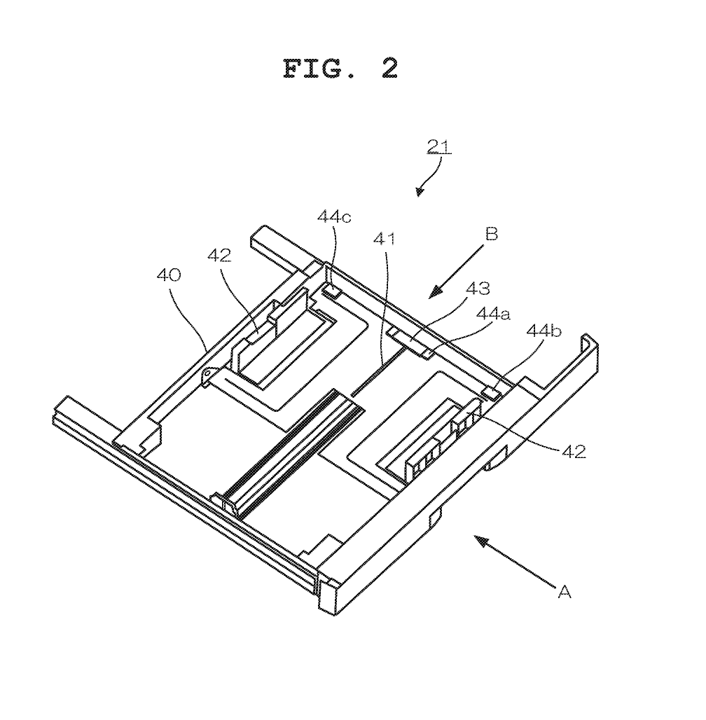

FIG. 2 is a perspective view showing the structure of the sheet cassette 21 according to the present embodiment. The sheet cassette 21 includes a housing 40, a cassette bottom plate 41 (a bottom plate section), and side regulation plates 42 (width regulation members). Sheets 22 are usually placed on the cassette bottom plate 41. The housing 40 and the side regulation plates 42 are structured and operated as with a general sheet cassette.

In the present embodiment, spacers 44a, 44b, and 44c and a DF prevention plate 43 (a double feed prevention section) are provided on the cassette bottom plate 41. Note that the DF prevention plate 43 made of a material such as a cork sheet having a predetermined coefficient of friction is arranged to prevent double feeding in the vicinity of the final sheet 22 on the spacer 44a arranged at the center of the cassette bottom plate 41. Also, the thickness of the spacers 44b and 44c is set such that the upper surface of each of the spacers 44b and 44c and the upper surface of the DF prevention plate 43 are at their respective plane positions having the same height. The DF prevention plate 43 may be formed at the same height as that of the spacer 44a in at least a partial area on the upper surface of the spacer 44a.

That is, in conventional techniques, the DF prevention plate 43 is provided to be at substantially the same plane position as the cassette bottom plate 41. However, in the present embodiment, supporting sections (first supporting sections) having the same height support the front end side of the sheet 22 by supporting three portions including the center and both ends of the sheets 22 at a position higher by the thickness of the spacer 44a and the thickness of the DF prevention plate 43 than the upper surface of the cassette bottom. plate 41 in an area where the spacers 44a, 44b, and 44c and the DF prevention plate 43 are not arranged.

That is, in the present embodiment, the upper surface of the cassette bottom plate 41 in an area where the supporting sections are not arranged is formed lower than the upper surface of each of the supporting sections.

Note that, although the support sections in the present embodiment are provided in three areas for the case where the width of a printing target medium has the A4 longitudinal size, the number of the supporting sections may be set to match the size and the property of a printing target medium. For example, in the case of a wide printing target medium, the number of the supporting sections may be increased.

The spacers 44a, 44b, and 44c are fixed with an adhesive tape or the like. These spacers 44a, 44b, and 44c are structured to be replaceable so that they can be set, as needed, depending on the weight (the thickness and the rigidity) of the release sheet 19 and the size of the curl of the release sheet 19 in addition to the height of the upper surface and the size (the area and the aspect ratio) of each of the spacers 44a, 44b, and 44c and the size and the thickness of the DF prevention plate 43. For example, when the curl is large, the thickness of each of the spacers 44a, 44b, and 44c should preferably be large. The material of the surface of each of the spacers 44a, 44b, and 44c is preferably a material such as polyoxymethylene (POM) having a low coefficient of friction on which an edge of the release sheet 19 is not easily caught.

Also, a relation between the thickness of the spacers 44a, 44b, and 44c and spacing thereamong is in a range where the curl is not buckled (the curl is crushed and is bent in a direction perpendicular to the original curl) or a range where a slack of the release sheet 19 occurring when the curl is buckled interferes with paper feeding so as not to cause a jam. In the present embodiment, the spaces 44a, 44b, and 44c are preferably arranged to ensure a length that is approximately 30 percent of the length in the sheet width direction (the direction perpendicular to the conveyance direction) of the release sheet 19 among the spaces 44a, 44b, and 44c. That is, the height of each of the spacers 44a, 44b, and 44c from the upper surface of the bottom plate section and the length in the perpendicular direction of the spacer are required to be in a range where the curl of the release sheet 19 is not buckled or a range where a slack of the release sheet 19 occurring when the curl is buckled interferes with paper feeding so as not to cause a jam.

Also, the type of the spacers 44a, 44b, and 44c may be selectable by providing a plurality of horizontally rectilinear scale marks at predetermined intervals (intervals of 0.5 mm) on a surface of each of the side regulation plates 42 which comes in contact with an end portion of the release sheet 19, and identifying the size of the curl of the release sheet 19 based on the number of scale marks with which the end portion of the release sheet 19 intersects.

Alternatively, the curl of the placed release sheet 19 may be able to be easily judged to be in an allowable range by providing, on a surface of the side regulation plate 42 which comes in contact with the end portion of the release sheet 19, a plurality of curvilinear scale marks representing a curl at the end portion of the release sheet 19 which is in an allowable range for sheet-passing.

Furthermore, the visibility may be enhanced by forming the side regulation plate 42 with a transparent material so that the above-described (rectilinear and curvilinear) scale marks with colors (including black) and the end portion of the release sheet 19 can be seen through the side regulation plate 42.

Note that, although the spacers 44a, 44b, and 44c in the present embodiment are removably provided with an adhesive tape, the present invention is not limited thereto. For example, convex portions may be respectively formed at the positions of the cassette bottom plate 41 corresponding to the spacers 44a, 44b, and 44c when the cassette bottom plate 41 is molded. That is, at least a partial area of the cassette bottom. plate 41 may be formed as the convex portions. In this case, since the friction should preferably be low as described above, the surface roughness of the spacers 44a, 44b, and 44c should preferably be lower in slippery surface treatment such as nickel (Ni) plating. At this time, the cassette bottom plate 41 may be structured to replaceable, corresponding to the type (the size, the thickness, and the stiffness) of the printing target medium and the size of the curl of the printing target medium. If the curl of a printing target medium is large, for example, the cassette bottom plate 41 whose convex portions have been made higher may be used.

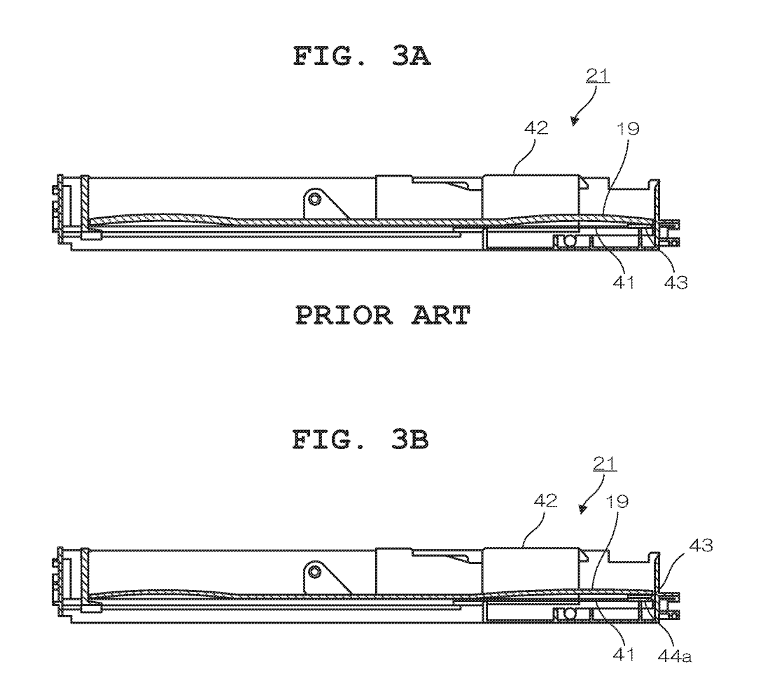

FIG. 3A and FIG. 3B are cross-sectional views showing the cross-sectional structure of the sheet cassette 21 when viewed from the arrow A direction in FIG. 2. FIG. 3A shows a general sheet cassette 21 including no spaces 44a, 44b, and 44c for comparison, and FIG. 3B shows a sheet cassette 21 including spacers 44a, 44b, and 44c according to the present embodiment.

As shown in FIG. 3A, when the curled release sheet 19 is placed on the general sheet cassette 21, the release sheet 19 is lifted up with respect to the cassette bottom plate 41 and is placed on the sheet cassette 21 with the front end in the sheet feeding direction being oriented downward. On the other hand, when the curled release sheet 19 is placed on the sheet cassette 21 in the present embodiment, the front end in the sheet feeding direction of the release sheet 19 is partially supported at a position higher than a surface of the cassette bottom plate 41 not including the DF prevention plate 43 raised by the spacer 44a and the spacers 44b and 44c, from below by the DF prevention plate 43 raised by the spacers 44a and the spacers 44b and 44c, as shown in FIG. 3B. Therefore, the degree to which the front end in the sheet feeding direction is oriented downward is more reduced than that in FIG. 3A, and the front end in the sheet feeding direction is substantially horizontal.

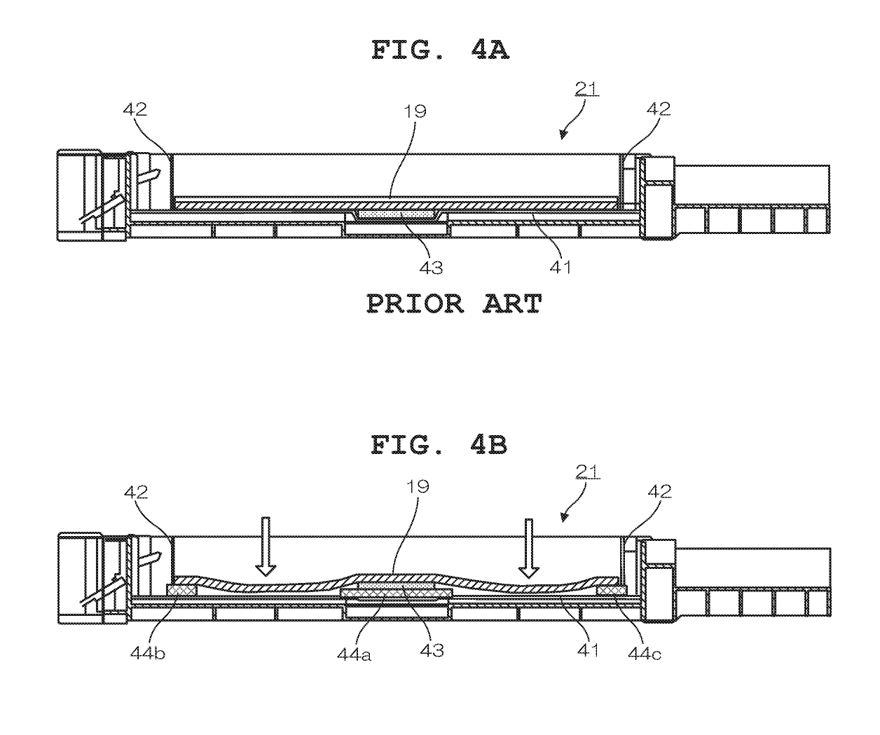

FIG. 4A and FIG. 4B are cross-sectional views showing the cross-sectional structure of the sheet cassette 21 when viewed from the arrow B direction shown in FIG. 2. FIG. 4A shows a general sheet cassette 21 including no spacers 44a, 44b, and 44c for comparison, and FIG. 4B shows a sheet cassette 21 including spacers 44a, 44b, and 44c according to the present embodiment.

When the curled release sheet 19 is placed on the general sheet cassette 21, the curled release sheet 19 becomes high-bulk by being lifted up near its end, as shown in FIG. 3A and FIG. 4A. Accordingly, the release sheet 19 also becomes high-bulk near its front end. That is, the release sheet 19 is oriented downward near the front end. On the other hand, when the curled release sheet 19 is placed on the sheet cassette 21 in the present embodiment, the sheet cassette 21 has the DF prevention plate 43 arranged at its center and the spacers 44b and 44c arranged at a high position on the cassette bottom plate 41 at its right and left ends, as shown in FIG. 3B. Therefore, force acts on the release sheet 19 in a direction to correct the curl of the release sheet 19. Furthermore, the release sheet 19 is supported on a portion including the DF prevention plate 43 and the spacers 44b and 44c but is not supported on a portion not including the DF prevention plate 43 and the spacers 44b and 44c. As a result, force causing the release sheet 19 to warp in a direction to press down the curl of the release sheet 19 acts on the release sheet 19 as indicated by arrows in FIG. 4B, by the own weight of the release sheet 19. This force makes an effect of suppressing the curl of the release sheet 19 in the original direction higher than that when the front end of the release sheet 19 is supported throughout.

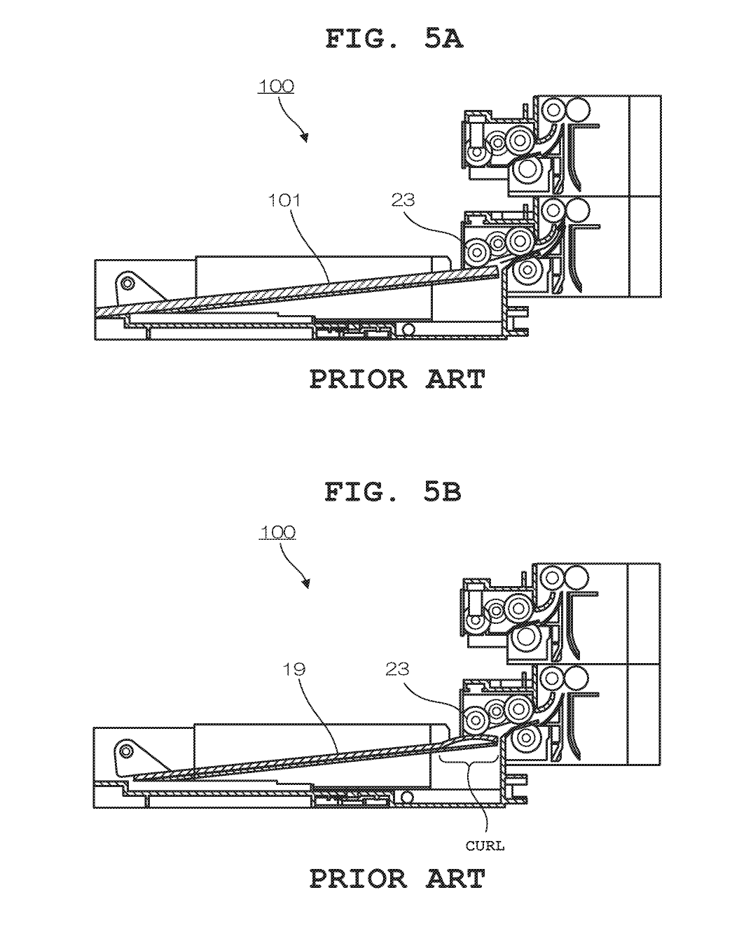

Thus, the release sheet 19, which has been fed in a state shown in FIG. 5B, is fed normally without causing malfunction because the degree of the downward orientation of the front end in the sheet feeding direction of the release sheet 19 becomes close to that while plain paper 101 is fed, as shown in FIG. 5A.

According to the above-described embodiment, when the plurality of spacers 44a, 44b, and 44c are arranged at predetermined intervals on the cassette bottom plate 41 in the sheet cassette 21 storing the release sheet 19, and the front end side of the release sheet 19 is supported by the supporting sections supporting a plurality of portions including the center and the ends of the release sheet 19 at a position higher than the sheet placing plane on the cassette bottom plate 41, the curled release sheet 19 can correct the original curve by its own weight. Furthermore, when force for causing the release sheet 19 to warp in a direction to press down the curl acts on the release sheet 19, the front end of the release sheet 19 can be inhibited from being lowered by the curl. As a result, the front end of the release sheet 19 can be made substantially flat as with plain paper. Therefore, the release sheet 19 can be stably fed by reducing folds at both ends of the release sheet 19 and a conveyance resistance in a guide turn portion of the release sheet 19.

Also, according to the above-described embodiment, the plurality of spacers 44a, 44b, and 44c are provided at the three portions, that is, both ends and the center in the direction perpendicular to the conveying direction of the release sheet 19, and the front end side of the release sheet 19 is supported by the plurality of portions, that is, the center and both ends of the release sheet 19 being supported at a high position on the cassette bottom plate 41. Therefore, the curled release sheet 19 can correct the curl by pressing down the curl by its own weight, and the front end of the release sheet 19 can be inhibited from being lowered by the curl. Note that the spacer 44a in an area at the center of the release sheet 19 is provided to share the design of the DF prevention plate 43 with conventional designed products. However, the DF prevention plate 43 can provide a substantially similar function to that of the spacer 44a depending on the thickness of the DF prevention plate 43. Accordingly, the spacer 44a can also be omitted.

Moreover, according to the above-described embodiment, the spacers 44a, 44b, and 44c are arranged spaced apart from one another to ensure the length which is approximately 30 percent of the length in the direction perpendicular to the conveyance direction of the release sheet 19, and the front end side of the release sheet 19 is supported by a plurality of portions, that is, the center and both ends of the release sheet 19 being supported at a high position on the cassette bottom plate 41. Therefore, the degree of the downward orientation of the front end in the feeding direction by the curl of the release sheet 19 can be reduced.

Furthermore, according to the above-described embodiment, the spacers 44a, 44b, and 44c are fixed on the cassette bottom plate 41 with an adhesive tape. Therefore, the height and the size (the area and the aspect ratio) of the supporting section can be changed depending on the type (the size, the thickness, and the stiffness) of the release sheet 19 and the size of the curl. Note that the spacers 44a, 44b, and 44c may be fixed using a hook and loop fastener and a magnet sheet instead of the adhesive tape. Also, the spacers 44a, 44b, and 44c may be formed by changing their respective colors such that they are easily distinguishable. Moreover, a fitting shape may be provided between the cassette bottom plate 41 and the affixing surface of each of the spacers 44a, 44b, and 44c such that they are fitted only at a specific arrangement position. Furthermore, the spacers 44a, 44b, and 44c may be integrated and made easily replaceable. In other words, the spacers 44a, 44b, and 44c may be connected to one another via a connection section (not shown).

Still further, according to the above-described embodiment, when the cassette bottom plate 41 is to be molded, the spacers 44a, 44b, and 44c are formed by a part of the cassette bottom plate 41 being molded into a convex shape. Therefore, complexity in the mounting of the spacers 44a, 44b, and 44c can be reduced.

When the height of the spacers 44a, 44b, and 44c is made too large to correspond to a high curl, the front end of a slack sheet may cause a feeding jam when the curl is buckled. Accordingly, a slack spacer (not shown) for supporting the release sheet 19 at a height between the upper surface of each of the spacers 44a, 44b, and 44c and the upper surface of the cassette bottom. plate 41 is arranged between the spacers. As a result, even if the curl of the release sheet 19 is buckled by the spacers 44a, 44b, and 44c, a slack amount of the release sheet 19 can be restricted. That is, when a slack spacer (a second supporting section) capable of supporting the release sheet 19 (a recording target medium) by restricting its height at a plane position lower than that of each of the spacers 44a, 44b, and 44c in an area where the spacers 44a, 44b, and 44c (a plurality of first supporting sections) are not provided is arranged on the cassette bottom plate 41 (a third supporting section), a jam caused by a slack can be prevented by restricting the slack amount of the release sheet 19 even if the curl of the release sheet 19 is buckled. If the slack spacer is provided at a height smaller by 0.5 mm than a height at which the recording target medium is supported using the spacers 44a, 44b, and 44c, the end portion of the release sheet 19 is prevented from being lowered by 0.5 mm or more among the spacers 44a, 44b, and 44c even if the curl of the release sheet 19 is completely buckled, and the slack is prevented from interfering with sheet feeding and causing a jam. Also, spacers 44a, 44b, and 44c having a large height, which can deal with a larger curl, can be used. As a matter of course, the slack spacer may be integrated with the spacers 44a, 44b, and 44c, or may be formed of a bottom plate portion, as described above.

If the height of the spacers 44a, 44b, and 44c (the plurality of first supporting sections) is sufficiently small, the slack spacer (the second supporting section) is not required. This is a special case where the height of the spacers 44a, 44b, and 44c is the same as the height of the cassette bottom plate 41 (the third supporting section), or in other words, the cassette bottom plate 41 (the third supporting section) also serves as the slack spacer (the second supporting section).

While the present invention has been described with reference to the preferred embodiments, it is intended that the invention be not limited by any of the details of the description therein but includes all the embodiments which fall within the scope of the appended claims.

What is claimed is:

1. A paper feeding apparatus comprising:
a bottom plate section where a printing target medium is placed; and
a plurality of supporting sections which are arranged at predetermined intervals in a direction perpendicular to a conveyance direction of the printing target medium, and support the printing target medium from below.

2. The paper feeding apparatus according to claim 1, wherein at least one of the plurality of supporting sections is arranged at center in the perpendicular direction.

3. The paper feeding apparatus according to claim 2, wherein at least one of the plurality of supporting sections is arranged at one end of the bottom plate section in the perpendicular direction, and
wherein at least one of the others of the plurality of supporting sections is arranged at the other end opposing the one end.

4. The paper feeding apparatus according to claim 2, wherein at least a partial area of an upper surface of the supporting section arranged at the center is formed as a double feeding prevention section.

5. The paper feeding apparatus according to claim 1, wherein the plurality of supporting sections are arranged at positions corresponding to a front end side of the printing target medium in the conveyance direction.

6. The paper feeding apparatus according to claim 1, wherein an upper surface of the bottom plate section in an area where the plurality of supporting sections are not arranged is formed lower than upper surfaces of the supporting sections.

7. The paper feeding apparatus according to claim 1, wherein the plurality of supporting sections support the printing target medium at respective plane positions having the same height.

8. The paper feeding apparatus according to claim 1, wherein the plurality of supporting sections are structured to be replaceable, corresponding to a type of the printing target medium and a size of a curl of the printing target medium.

9. The paper feeding apparatus according to claim 1, wherein the plurality of supporting sections are structured to be connected to one another via a connection section.

10. The paper feeding apparatus according to claim 1, wherein at least a partial area of the bottom plate section is formed as the supporting sections.

11. The paper feeding apparatus according to claim 10, wherein the bottom plate section is structured to be replaceable, corresponding to a type of the printing target medium and a size of a curl of the printing target medium.

12. The paper feeding apparatus according to claim 1, wherein the plurality of supporting sections are respectively formed in colors corresponding to positions where the supporting sections are arranged so as to be distinguishable.

13. The paper feeding apparatus according to claim 8, wherein the plurality of supporting sections are structured such that respective positions where the supporting sections are arranged are identified by fitting shapes corresponding to the bottom plate section and the positions being formed.

14. The paper feeding apparatus according to claim 1, wherein each of the plurality of supporting sections is formed such that a height thereof from an upper surface of the bottom plate section and a length thereof in the perpendicular direction are in a range where a slack occurring when a curl of the printing target medium is buckled does not interfere with sheet feeding.

15. The paper feeding apparatus according to claim 7, further comprising:
a slack supporting section which supports the printing target medium at a position higher than an upper surface of the bottom plate section and lower than a surface that is supported by the plurality of supporting sections, in an area where the plurality of supporting sections are not arranged,
wherein the slack supporting section restricts a slack amount of the printing target medium.

16. The paper feeding apparatus according to claim 1, further comprising:
a width regulation member which regulates the perpendicular direction of the printing target medium,
wherein the width regulation member has a plurality of horizontally rectilinear scale marks provided at predetermined intervals on a surface of the width regulation member that comes in contact with an end portion of the placed printing target medium so that a size of a curl of the printing target medium can be identified.

17. The paper feeding apparatus according to claim 1, further comprising:
a width regulation member which regulates the perpendicular direction of the printing target medium,
wherein the width regulation member has a plurality of curvilinear scale marks which are provided on a surface of the width regulation member that comes in contact with an end portion of the placed printing target medium according to a height and represents an allowable curl of the printing target medium so that a curl of the printing target medium can be judged to be within an allowable range.

18. The paper feeding apparatus according to claim 16, wherein the width regulation member is formed of a transparent material.

19. The paper feeding apparatus according to claim 17, wherein the width regulation member is formed of a transparent material.

20. An image forming apparatus comprising:
a transfer section which transfers a toner image to a printing target medium; and
a sheet feeding section which feeds the printing target medium to the transfer section,
wherein the sheet feeding section comprises a bottom plate section where the printing target medium is placed, and a plurality of supporting sections having a predetermined height arranged at predetermined intervals in a direction perpendicular to a conveyance direction of the printing target medium.
